(19) United States
(12) Patent Application Publication
(10) Pub. No.: US 2011/0197124 A1
(43) Pub. Date: Aug. 11, 2011

(54) Automatic Creation And Management Of Dynamic Content

(76) Inventor: Bryan Eli Garaventa, Pacifica, CA (US)

(21) Appl. No.: 13/020,937

(22) Filed: Feb. 4, 2011

Related U.S. Application Data
(60) Provisional application No. 61/301,636, filed on Feb. 5, 2010.

(51) Int. Cl. G06F 17/00; G06F 3/048

(52) U.S. Cl. 715/234

(57) ABSTRACT

A computer implemented method and system for creating and managing dynamic content on a web page is provided. An application programming interface that interacts with a user's browser application is provided. The browser application comprises multiple document objects contained in a document object model. A user input triggers retrieval of one or more dynamic content objects on the web page. The application programming interface dynamically retrieves the dynamic content objects from local and/or remotely hosted memory locations. The application programming interface updates the document object model using the retrieved dynamic content objects. The retrieved dynamic content objects define the document objects in the document object model. The application programming interface dynamically renders the retrieved dynamic content objects onto the web page from the document objects contained in the updated document object model. The application programming interface updates functionality of the rendered dynamic content objects on the web page at runtime.

### CROSS REFERENCE TO RELATED APPLICATIONS

This application claims the benefit of provisional patent application No. 61/301,636 titled “Automatic Creation And Management Of Dynamic Content”, filed on Feb. 5, 2010 in the United States Patent and Trademark Office.

The specification of the above referenced patent application is incorporated herein by reference in its entirety.

### BACKGROUND

Conventional content rendering applications for rendering dynamic content utilize additional resources of a user's computing device for retrieving the actual dynamic content prior to rendering the dynamic content to the user. The additional overhead created due to the utilization of the resources of the user's computing device results in creating a burden on the user's computing device. Also in cases where the content rendering applications render a dynamic content object, the dynamic content object lacks accessibility, for example, by other assistive technology software applications on the user's computing device that are required to enhance the functionality of the dynamic content object. Such content rendering applications require additional time to update the functionality of the dynamic content object and require manual intervention to clear a memory space occupied by the dynamic content object.

Hence, there is a long felt but unresolved need for a computer implemented method and system that creates and manages dynamic content on a web page, provides interfacing capabilities with dynamically retrieved and rendered dynamic content objects to other applications on the computing device, and provides seamless accessibility of the additional functionality of the dynamic content objects to assistive technology users.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for creating and managing dynamic content on a web page, providing interfacing capabilities with dynamically retrieved and rendered dynamic content objects to other applications on a user's computing device, and providing seamless accessibility of the additional functionality of the dynamic content objects, for example, to assistive technology users having disabilities.

The computer implemented method and system disclosed herein provides an application programming interface that interacts with a browser application on a user's computing device. As used herein, the term “application programming interface” refers to a software program that defines a set of rules and instructions for creating and managing dynamic content and serves as an interface between the user and the user's computing device. The application programming interface specifies a set of functions for interacting with the browser application on the user's computing device and for creating and managing dynamic content on a web page. The application programming interface allows creation and management of dynamic content on any web page that provides access to dynamic content within web applications, for example, rich internet applications. In an embodiment, the application programming interface is implemented as a plug-in, for example, a jQuery plug-in that powers interaction between JavaScript and a hypertext markup language (HTML). The application programming interface supports multiple browser applications accessible over multiple computing devices.

The application programming interface automates the task of creating and rendering dynamic content on the web page using performance and accessibility enhancing technologies. The application programming interface interacts with the user's browser application. The browser application comprises multiple document objects contained in a document object model. The user provides an input on the web page to trigger retrieval of one or more of multiple dynamic content objects. As used herein, the term “dynamic content objects” refers to instances of dynamic content. The application programming interface provides accessibility for each of the dynamic content objects.

The application programming interface dynamically retrieves one or more dynamic content objects from local memory locations and/or remotely hosted memory locations. In an embodiment, the application programming interface retrieves the dynamic content from, for example, internal, external, and remotely hosted resources, for example, document object model (DOM) nodes, text, hypertext markup language (HTML), extensible hypertext markup language (XHTML), extensible markup language (XML), external scripts, JavaScript object notation (JSON), JSON with padding (JSONP), and data from remotely hosted APIs at runtime. The application programming interface configures the dynamic content objects to process and render the dynamic content with advanced functionality. The application programming interface updates the document object model of the browser application using the retrieved dynamic content objects. The retrieved dynamic content objects define the document objects contained in the document object model. In an embodiment, the application programming interface dynamically generates one or more nested dynamic content objects in the retrieved dynamic content objects. The dynamically generated nested dynamic content objects are dormant prior to activation of the retrieved dynamic content objects.

The application programming interface dynamically renders the retrieved dynamic content objects onto the web page from the document objects contained in the updated document object model. The application programming interface enables the rendered dynamic content objects to conform to multiple content guidelines. The rendered dynamic content objects are interpretable by output devices that render the retrieved dynamic content objects to the user. The application programming interface updates functionality of the rendered dynamic content objects on the web page at runtime. In an embodiment, the application programming interface passes the retrieved dynamic content objects from one web page to another web page for sharing data and resources. The application programming interface automatically clears dormant dynamic content objects from the document object model for preventing cluttering and memory leaks in the document object model. The application programming interface, in communication with the browser application, thereby creates and manages the dynamic content on the web page. The application programming interface disclosed herein is used to create scalable, performance enhanced, resource efficient, and automatically accessible rich internet applications.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method for creating and managing dynamic content on a web page.

FIG. 2 illustrates a computer implemented system for creating and managing dynamic content on a web page.

FIG. 3 exemplarily illustrates the architecture of a computer system employed for creating and managing dynamic content on a web page.

FIG. 4 exemplarily illustrates a flow diagram for creating and managing dynamic content on a web page.

FIG. 5A exemplarily illustrates a weather application rendered as a dynamic content object on a web page by an application programming interface based on an input provided by a user.

FIG. 5B exemplarily illustrates a poetry application rendered as a dynamic content object on a web page by the application programming interface based on an input provided by a user.

FIGS. 6A-6C exemplarily illustrate an interactive form, a poetry excerpt link, and a list of menu options rendered as dynamic content objects on a web page by the application programming interface based on an input provided by a user.

FIGS. 7A-7B exemplarily illustrate a map rendered as a dynamic content object on a web page by the application programming interface based on an input provided by a user.

FIG. 8 exemplarily illustrates locking of dynamic content objects on a web page by the application programming interface based on an input by the user.

FIGS. 9A-9B exemplarily illustrate a code component that defines a document object in a document object model using a retrieved dynamic content object.

FIG. 10 exemplarily illustrates a chat icon on a web page for triggering a chat component as a dynamic content object on the web page.

FIG. 11 exemplarily illustrates images rendered as dynamic content objects on a web page by the application programming interface.

FIG. 12 exemplarily illustrates extensible markup language generated drop down menus rendered as nested dynamic content objects on a web page by the application programming interface.

FIG. 13 exemplarily illustrates an audio visual player rendered as a nested dynamic content object on a web page by the application programming interface.

### DETAILED DESCRIPTION OF THE INVENTION

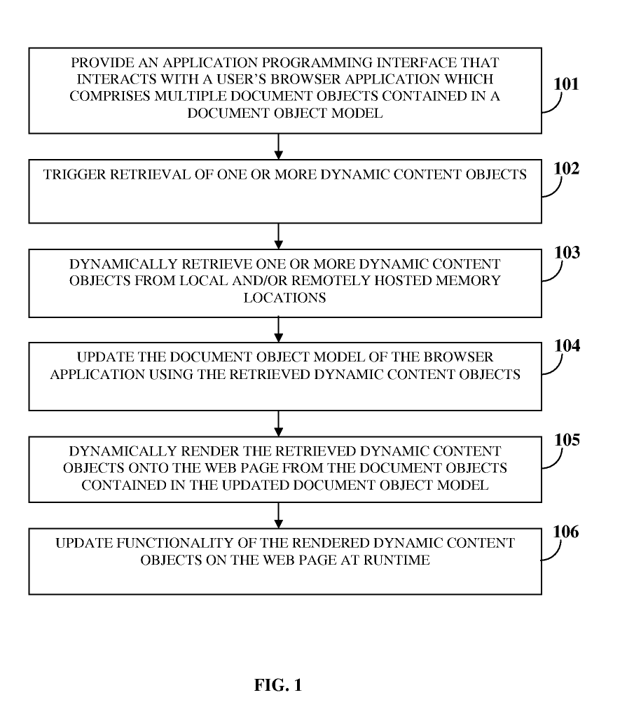

FIG. 1 illustrates a computer implemented method for creating and managing dynamic content on a web page. An application programming interface is provided 101 on a browser application of a user's computing device. As used herein, the term “application programming interface” refers to a software program that defines a set of rules and instructions for creating and managing dynamic content and serves as an interface between the user and the user's computing device. The application programming interface can be run locally on the user's computing device or from any domain. The application programming interface utilizes a cloud computing environment to instantly provide processes in rich internet application development.

The application programming interface allows creation and management of dynamic content on any web page that provides access to dynamic content within web applications, for example, rich internet applications. As used herein, the term “dynamic content” refers to content, for example, textual content, video content, audio content, content in applications such as rich internet applications, etc., or any combination thereof, that changes or can be varied for each individual viewing. The dynamic content is any type of static or interactive content that is dynamically rendered within a document object model (DOM) at runtime. Also, as used herein, the term “document object model” refers to a cross-platform and language-independent structure that represents and interacts with objects in, for example, hypertext markup language (HTML) documents, extensible hypertext markup language (XHTML) documents, extensible markup language (XML) documents, etc. The application programming interface specifies a set of functions for interacting with the browser application and for creating and managing dynamic content on a web page. In an embodiment, the application programming interface is implemented as a plug-in, for example, a jQuery plug-in that powers interaction between JavaScript and a hypertext markup language (HTML). JQuery is a JavaScript library used to power the application programming interface for cross browser compatibility.

The application programming interface interacts with the browser application on the user's computing device, for example, a personal computer, a mobile phone, a tablet computer, a personal digital assistant, etc. The browser application is, for example, a web browser such as Internet Explorer® of Microsoft Corporation, Firefox® of Mozilla Corporation, etc., that retrieves, displays, and allows exchange of content resources on the world wide web. The browser application comprises multiple document objects contained in the document object model. As used herein, the term “document objects” refers to entities that are controlled by commands of a programming language, for example, JavaScript. The application programming interface supports multiple browser applications accessible over multiple computing devices, for example, mobile devices, desktops, laptops, handheld devices, tablet computing devices, etc. The application programming interface supports cross browser compatibility for computing devices.

The user provides an input, for example, by clicking a link, a button, etc., or by moving a cursor over an image link on the web page, to trigger 102 retrieval of one or more dynamic content objects. As used herein, the term “dynamic content objects” refers to instances of dynamic content. The application programming interface disclosed herein dynamically retrieves 103 one or more dynamic content objects from one or more local memory locations and/or remotely hosted memory locations. For example, the application programming interface retrieves the dynamic content objects from remote application programming interfaces (APIs) such as Google™, Amazon.com®, PayPal™ of PayPal Pte. Ltd., flickr° of Yahoo! Inc., Facebook, or from any other remotely hosted application programming interface (API) using minimal code to maximize speed and efficiency. The application programming interface also retrieves the dynamic content objects from embedded script files, plug-ins, and other data sources. In an embodiment, the application programming interface uses an identification (ID) property to uniquely identify each retrieved dynamic content object among the retrieved dynamic content objects. The application programming interface can be dynamically configured to retrieve dynamic content from differing resource types at runtime. The application programming interface can further retrieve the content from, for example, internal, external, and remotely hosted resources, for example, DOM nodes, text, HTML, XHTML, XML, external scripts, JavaScript object notation (JSON), JSON with padding (JSONP), and data from remotely hosted APIs at runtime. The application programming interface configures or generates the dynamic content objects to process and render the dynamic content with advanced functionality on the web page.

In an embodiment, the application programming interface dynamically generates unlimited nested dynamic content objects in the retrieved dynamic content objects. The dynamic content objects can include nested dynamic content objects infinitely in a limitless recursion process. The generated nested dynamic content objects are dormant prior to the activation of the retrieved dynamic content objects. In an embodiment, scripts, remotely hosted application programming interface calls, resource locators of each dynamic content object, etc., remain dormant until the dynamic content object is activated. Unlimited dynamic content objects containing nested dynamic content objects can also be created to build complex web and web-based desktop applications with minimal footprints. The nested dynamic content objects are used to render user interface components, for example, dialogs, toolbars, menus, prompts, tooltips, tab pages, navigation panels, draggable windows, other visually displayed user interface components, etc., on the web page. The user interface components are configurable by changing or invoking properties and methods within each nested dynamic content object during setup or at runtime. Therefore, page speed and performance are improved as nested dynamic content objects within external sources are ignored until each of the nested dynamic content objects is required in turn. Unlimited dynamic content objects can be added on the web page without negatively affecting browser resources or web page performance, thereby allowing for fast load times for complex web applications.

The internal properties, methods, or objects within the dynamic content objects or group of dynamic content objects can be overridden to change the default functionality as needed during the setup process. Similarly, the dynamic content object properties, methods, and objects can be changed at runtime through the globally accessible document objects within the document object model. New properties, methods, and objects can also be added during the setup process, for example, using JavaScript to extend the functionality of any dynamic content object or group of dynamic content objects. In an embodiment, the application programming interface defines an object, for example, “reg”, to access, invoke, change or extend functionality of any dynamic content object or group of dynamic content objects at runtime, for example, using a unique identifier provided to each of the dynamic content objects using the ID property. Similarly, new properties, methods, and objects can be added through the globally accessible document objects within the document object model, for example, using JavaScript to extend the functionality of any dynamic content object or group of dynamic content objects at runtime.

The application programming interface provides automatic accessibility and interfacing capabilities for each of the dynamic content objects. For example, the dynamic content objects can be automatically accessed by assistive technology applications installed on or accessed by the user's computing device. The assistive technology applications comprise, for example, assistive, adaptive, or rehabilitative applications utilized by users having disabilities.

The application programming interface updates 104 the document object model of the browser application using the retrieved dynamic content objects. The retrieved dynamic content objects define the document objects in the document object model. The application programming interface disclosed herein dynamically renders 105 the retrieved dynamic content objects onto the web page from the document objects contained in the updated document object model. In an embodiment, the application programming interface defines, for example, a source property, in conjunction with a mode property to determine how dynamic content within a dynamic content object is retrieved, processed, and rendered. In an embodiment, the application programming interface passes the retrieved dynamic content objects from one web page to another web page for sharing data and resources.

In an embodiment, the application programming interface defines a function, for example, close( ) in JavaScript, to close the rendered dynamic content object. The application programming interface disclosed herein automatically removes closed dynamic content objects from the document object model (DOM) to prevent cluttering and memory leaks in the document object model, thereby allowing complex applications to be used indefinitely without degrading performance. The application programming interface automatically clears dormant dynamic content objects from the document object model. In an embodiment, the application programming interface defines a function, for example, fn.destroy( ) in JavaScript to destroy and remove the dynamic content objects from the document object model. The dynamic content objects retrieved from server side callbacks have the same level of quality, performance, and accessibility as internally referenced dynamic content objects. In an embodiment, the application programming interface defines a function, for example, fn.find( ) in JavaScript to execute a callback function on any dynamic content object at runtime.

The application programming interface disclosed herein executes automated maintenance and check routines to prevent the occurrence of document object model cluttering, memory leaks, object conflicts, and performance degrading during prolonged activity. The automated maintenance routines ensure that the dynamic content objects are removed from the document object model when closed to prevent cluttering. The automated check routines ensure that the dynamic content objects include uniquely defined identifiers when opened to prevent object instantiation conflicts. Perpetual instantiation allows the dynamic content objects to be configured or invoked regardless of whether the dynamic content objects exist within the document object model. When a user closes the rendered dynamic content objects and when the dynamic content objects are removed from the document object model, perpetual instantiation ensures that the same dynamic content objects still exist within the memory and can subsequently be reopened within the document object model using JavaScript. For example, properties, methods, and objects in the closed dynamic content objects can be added, modified, or overridden using JavaScript before the dynamic content objects are reopened within the document object model at runtime.

The rendered dynamic content objects are interpretable by standard output devices that render the retrieved dynamic content objects to the user. For example, the rendered dynamic content objects are interpretable by a printer, a display monitor, etc. The application programming interface ensures that dynamic content objects conform to relative web content accessibility guidelines (WCAG). The WCAG is a collection of global development standards that can be used to enhance accessibility for web-based technologies. The dynamic content objects are screen reader accessible when rendered to streamline development for large scale deployment, providing automatic conformance to relative WCAG. WCAG cover a wide range of recommendations for making web content more accessible. The application programming interface enables automatic conformance to the WCAG and therefore makes content accessible to a wider range of people with disabilities, including blindness and low vision, deafness and hearing loss, learning disabilities, cognitive limitations, limited movement, speech disabilities, photosensitivity, and combinations of these, and makes web content more usable to users in general. For example, dynamic content objects include automatic processing to ensure keyboard accessibility, screen reader accessible hidden text and a hidden close link to ensure that dynamic content objects can be navigated to and closed from the keyboard. Similarly, when rendering a set of automated tab controls, screen reader accessible hidden text, for example, “tab” or “tab selected” is automatically appended to the triggering link text to convey both role and state information to screen reader users. The screen reader accessible hidden text for tab controls can be overridden or changed during setup or at runtime allowing screen reader support in multiple linguistic dialects using any textual value.

The application programming interface disclosed herein updates 106 the functionality of the rendered dynamic content objects on the web page at runtime. The application programming interface provides access to the internal functionality of dynamic content objects at runtime to change or query the methods and the properties of each of the dynamic content objects for advancing the functionality of the dynamic content objects. The application programming interface uses scripts in the document object model to access and manipulate the properties and methods of the dynamic content objects for conditional processing. For example, the application programming interface can forcibly open and close any of the dynamic content objects using the scripts in the document object model. The application programming interface also uses the scripts to query and invoke the properties and methods of one or more dynamic content objects at runtime. The application programming interface also declares new properties or methods during the setup process to update the functionality of the dynamic content objects. For example, the dynamic content objects can utilize cascading style sheet (CSS) to automate visual effects, and include the ability to modify automated visual effects at runtime. The application programming interface allows modification and/or enhancement of behavior, functionality, appearances, and content of the dynamic content objects at runtime.

The functionality of the dynamic content objects can be accessed by screen reader users and keyboard only users. The application programming interface ensures that the dynamic content objects are automatically accessible to screen reader and keyboard only users when rendered. In an embodiment, the dynamic content objects comprise, for example, screen reader accessible hidden text, strategic document object model (DOM) insertion, strategic focus positioning, and accessible rich internet application (ARIA) live region markup, to automatically aid accessibility for screen reader and keyboard only users. Strategic DOM insertion can be used to ensure the reading order accessibility of the dynamic content object for screen reader and keyboard only users. Strategic focus positioning can be used to route focus to and from the dynamic content object when opened or closed to ensure keyboard accessibility for screen reader and keyboard only users. ARIA is a browser technology developed by the web accessibility initiative (WAI) to create rich internet applications that are automatically accessible to assistive technologies, for example, screen readers, screen magnifiers, and speech recognition software, that are used to enhance accessibility for disabled users. ARIA live region markup can be used to apply an invisible heading structure to a dynamic content object for screen reader users.

The dynamic content objects can utilize an automatic accessibility algorithm implemented by the application programming interface to force leading screen readers to recognize dynamic content changes immediately. The automatic accessibility algorithm forces screen readers to recognize dynamic content changes immediately by updating key attribute values and content within strategically positioned HTML tags within the document object model at runtime. In an embodiment, the application programming interface refreshes the document object model for screen reader users if the rendered dynamic content is not automatically recognized. The application programming interface implements an “announce” function for sending text messages that are automatically announced by leading screen readers at runtime.

The dynamic content object is registered in the document object model along with a unique identifier (ID) to ensure proper functionality and to prevent conflicts between other dynamic content objects during processing. Each dynamic content object declaration requires an object or cascading style sheet (CSS) selector, where the object or CSS selector points to an active element that acts as a triggering element for the dynamic content object. There is generally one active element but it is possible to use a CSS selector that references one or more dynamic content objects such as a link in a header and a footer. The CSS selector for one or more document object model (DOM) nodes determines a target zone for the dynamic content object. The target zone is a location within the document object model where the dynamic content object is inserted. In an embodiment, the target zone can be set, reassigned or removed at runtime. In another embodiment, the application programming interface defines a function, for example, fn.morph( ) in JavaScript, to convert a DOM node to a dynamic content object at runtime. A brief and descriptive role is required for each of the dynamic content objects. The descriptive role is visually hidden but can be seen by screen reader users. For example, descriptive roles can be a “help dialog”, “calendar picker”, “extended tool tip”, “alert”, “menu” or any other textual value, which indicates the purpose of the dynamic content object. The descriptive role within a dynamic content object can be changed during setup or at runtime to allow for localization in multiple linguistic dialects.

In an embodiment, the application programming interface provides one or more triggering elements for triggering the dynamic content objects. The triggering elements are objects that trigger opening or activation of the dynamic content objects. In an embodiment, cascading style sheet (CSS) selectors associate the dynamic content objects with one or more of the triggering elements at runtime. The application programming interface defines a property, for example, a trigger, to bind one or more necessary events to the triggering elements for activating the dynamic content objects. The application programming interface defines a property, for example, bind, to assign necessary event binders to the triggering elements. As used herein, the term “event binder” refers to an event, for example, a click, associated with any event handler, which has been registered with the browser application. Also, as used herein, the term “event handler” refers to a piece of executable code that handles interactions received in a computer program. In an embodiment, the application programming interface defines a function, for example, open( ) in JavaScript, to trigger the dynamic content object.

Event binders are used to activate the dynamic content objects. A dynamic content object contains functionality, which can be accessed by the keyboard. The functionality, which can be accessed by the keyboard, is used in combination with the descriptive role to indicate the boundaries of each dynamic content object and to provide a hidden close link for screen reader users.

Event binders are declared within their properties during the initial setup process to register the event handlers, which trigger objects. For example, “bind: ‘click’” and “bind: ‘click focus mouseover’” are valid event binder declarations. The properties, methods, and objects within each dynamic content object can be overridden or changed during setup or at runtime to customize the functionality of the dynamic content object. For example, the supplementary descriptive role properties that can be overridden during the setup process or at runtime are, for example, “start”, “end”, and “close”. The supplementary descriptive role properties help in providing screen reader localization support in multiple linguistic dialects when they are overridden. In an embodiment, the application programming interface exposes property controlled behavior switches for programmatic configuration. Dynamic content objects are not created during the setup process, resulting in faster load-times for high profile websites. Furthermore, external and remotely hosted sources can be used to render server side content immediately.

Since the application programming interface disclosed herein runs at the top level of the document object model, the application programming interface can be invoked within separate declarations as many times as needed to group different types of dynamic content. The application programming interface comprises an invocation function that accepts, for example, four arguments. The first argument is an array that includes each dynamic content object declaration to register within the document object model. The second is a key/value mapping object to extend or override global functionality within all dynamic content objects declared in the current invocation function. The third argument specifies that the current invocation function only runs after the web page has fully loaded in the browser application. The fourth argument determines whether asynchronous processing should be used during the dynamic content object registration process to minimize performance delays.

The invocation function initializes resource mappings for the dynamic content objects to be registered in the document object model. The declared instances of the application programming interface can be locally or globally extended to perform new operations as properties and methods are added or overridden during setup or at runtime. For example, to add or override properties and methods for the dynamic content objects declared in the current application programming interface invocation using global scope, new properties and methods are declared within the application programming interface invocation function by passing a collection object to a second parameter during setup. The collection object is a group of related objects. These properties, methods, and objects are globally applied to the dynamic content objects declared in the first parameter containing an array of dynamic content objects to register during setup. The feature of local or global extension of properties, methods, and objects makes it possible to shape or fit dynamic content objects into any product or utility that creates and renders automatically accessible dynamic content. A dynamic content object, once instantiated, can be accessed from any other dynamic content object or intra-document scripts to invoke, query, add or override any property, method, or object within any dynamic content object at runtime. The globally accessible instance of the application programming interface within the document object model exposes all instantiated dynamic content objects at runtime.

The application programming interface provides scalable and dynamic content management to power complex behaviors in web applications, for example, rich internet applications, etc., ensuring automatic accessibility for assistive technology users. The application programming interface maximizes the speed and efficiency of web applications by instantiating dynamic content objects when explicitly activated. The dynamic content objects can be configured, modified, extended, invoked, and controlled at runtime. The application programming interface disclosed herein utilizes, for example, unobtrusive JavaScript and interchangeable code objects to maximize performance and code manageability. The dynamic content object does not require embedded scripting to render the dynamic content objects in the document object model. The code objects are a sequence of instructions to a computing device to perform a specific task. Differing programming tasks can now be delegated to multiple development teams to assemble the code objects with reliable results.

In an embodiment, flexible interfaces can be created by interfacing with the code objects to share, invoke, or inherit properties and methods. The code objects' behavior, property, and functionality can be invoked by external scripts written, for example, in JavaScript. Code objects process flags can be set within code objects to indicate processing milestones for error handling and bug reporting. The application programming interface provides a flow controlled process for debugging programming code. The application programming interface utilizes flow control to ensure a script execution order. In an embodiment, the behavior, functionality and properties associated with the dynamic content objects can be enhanced at runtime by modifying the behavior, functionality, and properties of the code objects. The dynamic content objects can be passed from one web page to another web page as JavaScript object notation (JSON) strings and converted back to dynamic content objects for continued interaction.

The application programming interface disclosed herein increases the performance of a web page by importing external content including, for example, supporting script files, plug-ins, etc., on an as-needed basis at runtime. The supporting script files, plug-ins, and remotely hosted resources are dormant until the instant when each dynamic content object is rendered. As a result, no dynamic content objects are created during the setup process, allowing for fast load-times for high profile web applications, for example, rich internet applications. The application programming interface in communication with the browser application therefore creates and manages dynamic content within the web application.

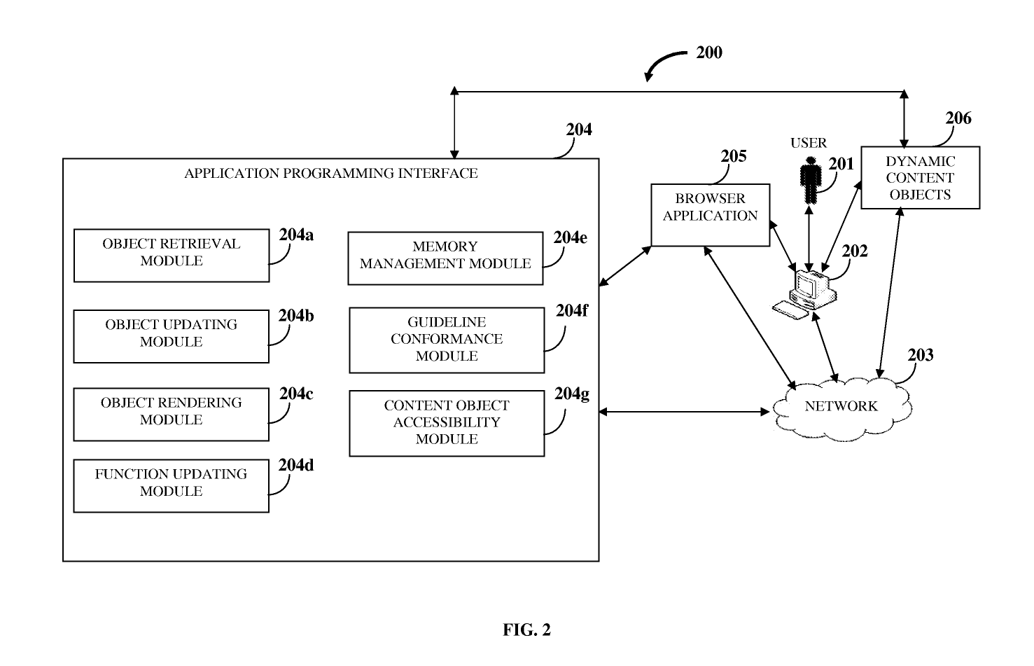

FIG. 2 illustrates a computer implemented system 200 for creating and managing dynamic content on a web page. The computer implemented system 200 disclosed herein comprises an application programming interface 204 that interacts with a browser application 205 on a user's 201 computing device 202. The browser application 205 comprises multiple document objects contained in a document object model. In an embodiment, the application programming interface 204 is accessible via a network 203. The application programming interface 204 comprises an object retrieval module 204a, an object updating module 204b, an object rendering module 204c, a function updating module 204d, a memory management module 204e, a guideline conformance module 204f, and a content object accessibility module 204g.

The object retrieval module 204a triggers retrieval of one or more dynamic content objects 206 on the web page based on a user's 201 input. The object retrieval module 204a dynamically retrieves the dynamic content objects 206 from one or more local memory locations and/or remotely hosted memory locations via the network 203. The object updating module 204b updates the document object model of the browser application 205 using the retrieved dynamic content objects 206. The retrieved dynamic content objects 206 define the document objects in the document object model. In an embodiment, the object updating module 204b dynamically generates one or more nested dynamic content objects 206 in the retrieved dynamic content objects 206. The dynamically generated nested dynamic content objects 206 are dormant prior to activation of the retrieved dynamic content objects 206.

The object rendering module 204c dynamically renders the retrieved dynamic content objects 206 onto the web page from the document objects contained in the updated document object model. In an embodiment, the object rendering module 204c passes one or more of the retrieved dynamic content objects 206 from one web page to another web page for sharing data and resources. The function updating module 204d updates functionality of the rendered dynamic content objects 206 on the web page at runtime. The memory management module 204e automatically clears dormant dynamic content objects 206 from the document object model for preventing cluttering and memory leaks in the document object model. The guideline conformance module 204f enables the rendered dynamic content objects 206 to conform to content guidelines, for example, web content accessibility guidelines (WCAG) as disclosed in the detailed description of FIG. 1. The content object accessibility module 204g provides accessibility for each of the dynamic content objects 206.

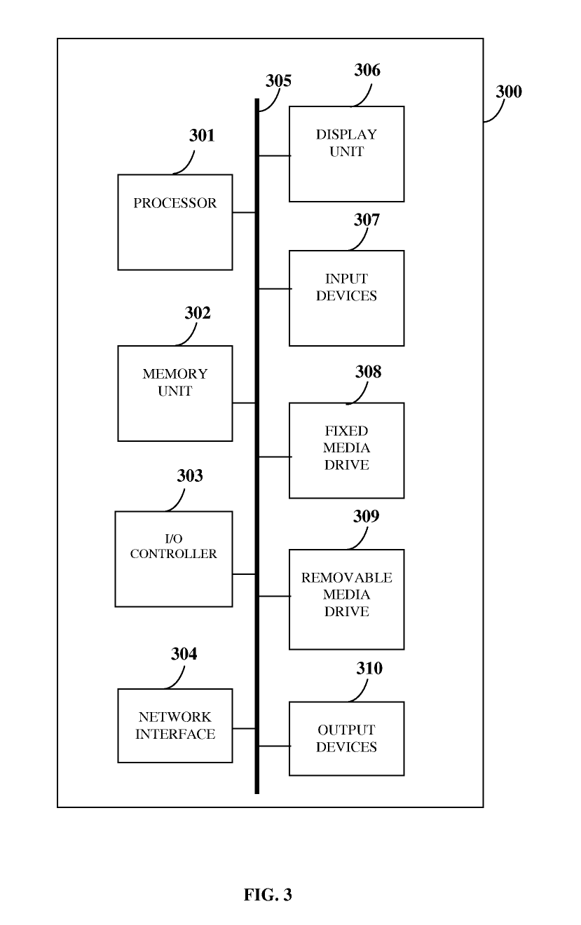

FIG. 3 exemplarily illustrates the architecture of a computer system 300 employed for creating and managing dynamic content on a web page. In an embodiment, the application programming interface 204 of the computer implemented system 200 disclosed herein employs the architecture of the computer system 300 exemplarily illustrated in FIG. 3 for creating and managing dynamic content on a web page. The application programming interface 204 is deployed on the browser application 205 on the user's 201 computing device 202. The application programming interface 204 is accessible by the browser application 205. The application programming interface 204 dynamically retrieves the dynamic content objects 206 from one or more local memory locations and/or remotely hosted memory locations, for example, via the network 203 such as a short range network or a long range network. The network 203 is, for example, a local area network (LAN), a wide area network, a mobile communication network, etc. The computer system 300 comprises, for example, a processor 301, a memory unit 302 for storing programs and data, an input/output (I/O) controller 303, a network interface 304 that may access wireless networks such as the network 203, a data bus 305, a display unit 306, input devices 307, a fixed media drive 308, a removable media drive 309, output devices 310, etc.

The processor 301 is an electronic circuit that executes computer programs. The memory unit 302 is used for storing programs, applications, and data. The application programming interface 204 is stored on the memory unit 302 or the media drives 308 and 309 of the computer system 300. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301.

The network interface 304 enables connection of the computer system 300 to the network 203. The computer system 300 communicates with other computer systems, for example, through the network interface 304. The network interface 304 is, for example, a Bluetooth™ interface, an infrared (IR) interface, a WiFi interface, a universal serial bus interface (USB), a local area network (LAN) or wide area network (WAN) interface, etc. The I/O controller 303 controls the input actions of the user 201 on the browser application 205, for example, a mouse click or a keystroke on the browser application 205, etc., and output actions of the browser application 205. The data bus 305 permits communications between the modules, for example, 204a, 204b, 204c, 204d, 204e, 204f, and 204g of the application programming interface 204 deployed on the computer system 300.

The display unit 306 displays, via the browser application 205, the results of the object retrieval module 204a, the object updating module 204b, the object rendering module 204c, the function updating module 204d, the memory management module 204e, the guideline conformation module 204f, and the content object accessibility module 204g on the web page. The input devices 307 are used for inputting data into the computer system 300. The input devices 307 are, for example, a keyboard such as an alphanumeric keyboard, a joystick, a mouse, a touch pad, a light pen, microphone, etc.

The computer system 300 further comprises a fixed media drive 308, for example, a hard drive, and a removable media drive 309. The removable media drive 309 receives removable media. Computer applications and programs are used for operating the computer system 300. The programs are loaded onto the fixed media drive 308 and into the memory unit 302 of the computer system 300 via the removable media drive 309, or the network interface 304. In an embodiment, the computer applications and programs may be loaded directly through the network 203. Computer applications and programs are executed by double clicking a related icon displayed on the display unit 306 using one of the input devices 307. The user 201 interacts with the computer system 300 via the browser application 205 using the display unit 306.

The computer system 300 employs an operating system for performing multiple tasks. The operating system is responsible for management and coordination of activities and sharing of the resources of the computer system 300. The operating system further manages security of the computer system 300, peripheral devices connected to the computer system 300, and network connections. The operating system employed on the computer system 300 recognizes, for example, inputs provided by the user 201 using one of the input devices 307, the output display, files and directories stored locally on the fixed media drive 308, etc. The operating system on the computer system 300 executes different programs, for example, the browser application 205, an electronic mail application, etc., initiated by the user 201 using the processor 301. Instructions for executing the modules 204a, 204b, 204c, 204d, 204e, 204f, and 204g of the application programming interface 204 are retrieved by the processor 301 from the program memory in the form of signals. A program counter (PC) determines locations of the instructions in the program memory. The program counter stores a number that identifies the current position in the program of the modules 204a, 204b, 204c, 204d, 204e, 204f, and 204g of the application programming interface 204.

The instructions fetched by the processor 301 from the program memory after being processed are decoded. The instructions are placed in an instruction register (IR) in the processor 301. After processing and decoding, the processor 301 executes the instructions. For example, the object retrieval module 204a defines instructions for triggering retrieval of one or more dynamic content objects 206 on the web page based on a user's 201 input and for dynamically retrieving the dynamic content objects 206 from one or more local memory locations and/or remotely hosted memory locations. The object updating module 204b defines instructions for updating the document object model of the browser application 205 using the retrieved dynamic content objects 206. The object updating module 204b defines instructions for generating one or more nested dynamic content objects 206 in the retrieved dynamic content objects 206. The object rendering module 204c defines instructions for dynamically rendering the retrieved dynamic content objects 206 onto the web page from the document objects contained in the updated document object model. The object rendering module 204c defines instructions for passing the retrieved dynamic content objects 206 from one web page to another web page for sharing data and resources. The function updating module 204d defines instructions for updating functionality of the rendered dynamic content objects 206 on the web page at runtime. The memory management module 204e defines instructions for automatically clearing dormant dynamic content objects 206 from the document object model for preventing cluttering and memory leaks in the document object model. The guideline conformance module 204f defines instructions for enabling the rendered dynamic content objects 206 to conform to multiple content guidelines. The content object accessibility module 204g defines instructions for providing accessibility for each of the dynamic content objects 206.

The processor 301 retrieves the instructions defined by the object retrieval module 204a, the object updating module 204b, the object rendering module 204c, the function updating module 204d, the memory management module 204e, the guideline conformance module 204f, and the content object accessibility module 204g of the application programming interface 204, and executes the instructions.

At the time of execution, the instructions stored in the instruction register are examined to determine the operations to be performed. The operations include arithmetic and logic operations. The processor 301 then performs the specified operations. The operating system performs multiple routines for performing a number of tasks required to assign the input devices 307, the output devices 310, and memory for execution of the modules 204a, 204b, 204c, 204d, 204e, 204f, and 204g of the application programming interface 204. The tasks performed by the operating system comprise assigning memory to the modules 204a, 204b, 204c, 204d, 204e, 204f, and 204g of the application programming interface 204 and data, moving data between the memory unit 302 and disk units, and handling input/output operations. The operating system performs the tasks, on request, by the operations and after performing the tasks, the operating system transfers the execution control back to the processor 301. The processor 301 continues the execution to obtain one or more outputs. The outputs of the execution of the modules 204a, 204b, 204c, 204d, 204e, 204f, and 204g of the application programming interface 204 are displayed to the user 201 via the browser application 205.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 301, except for a transitory, propagating signal.

The computer program product disclosed herein comprises multiple computer program codes for creating and managing dynamic content on a web page. For example, the computer program product disclosed herein comprises computer program codes for providing the application programming interface 204 that interacts with the browser application 205, triggering retrieval of one or more dynamic content objects 206 based on an input provided by the user 201, dynamically retrieving the dynamic content objects 206 from one or more of local memory locations and/or remotely hosted memory locations, updating the document object model of the browser application 205 using the retrieved dynamic content objects 206, dynamically rendering the retrieved dynamic content objects 206 onto the web page from the document objects contained in the updated document object model, and updating functionality of the rendered dynamic content objects 206 on the web page at runtime. The computer program product disclosed herein further comprises computer program codes for dynamically generating one or more nested dynamic content objects 206 in the retrieved dynamic content objects 206, automatically clearing dormant dynamic content objects 206 from the document object model for preventing cluttering and memory leaks in the document object model, enabling the rendered dynamic content objects 206 to conform to multiple content guidelines, and passing the retrieved the dynamic content objects 206 from one web page to another web page for sharing data and resources. The computer program product disclosed herein further comprises additional computer program codes for performing additional steps that may be required and contemplated for creating and managing dynamic content on a web page.

The computer program codes comprising the computer executable instructions are embodied on the non-transitory computer readable storage medium. The processor 301 of the computer system 300 retrieves these computer executable instructions and executes them. When the computer executable instructions embodied on the non-transitory computer readable storage medium are executed by the processor 301, the computer executable instructions cause the processor 301 to perform the method steps for creating and managing dynamic content on a web page. In an embodiment, a single piece of computer program code comprising computer executable instructions performs one or more steps of the computer implemented method disclosed herein for creating and managing dynamic content on a web page.

For purposes of illustration, the detailed description refers to the application programming interface 204 being run locally on the computer system 300; however the scope of the computer implemented method and system 200 disclosed herein is not limited to the application programming interface 204 being run locally on the computer system 300 via the operating system and the processor 301 but may be extended to run over the network 203, for example, the internet by employing a remote web server.

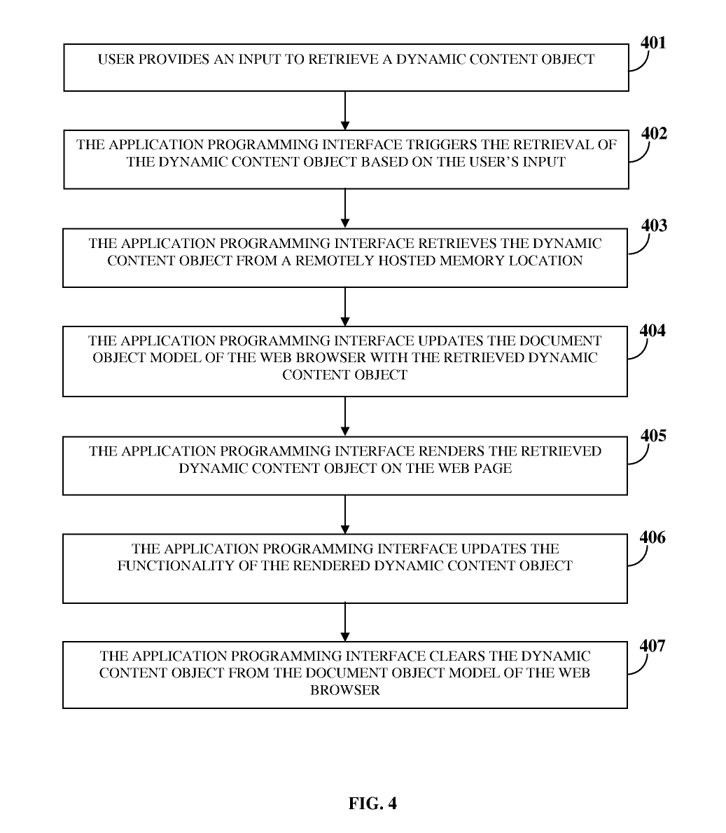

FIG. 4 exemplarily illustrates a flow diagram for creating and managing dynamic content on a web page. Consider an example where a user 201 provides 401 an input by clicking on a link to retrieve a dynamic content object 206, for example, a news section, on the webpage of a website accessed using a browser application 205 such as a web browser. The application programming interface 204 triggers 402 the retrieval of the news section based on the user's 201 input. The application programming interface 204 retrieves 403 the news section from a remotely hosted memory location, for example, a hosting server of the website. The application programming interface 204 updates 404 the document object model of the web browser with the retrieved dynamically updated news section. The application programming interface 204 renders 405 the dynamically updated news section on the web page via the web browser. The news section is updated periodically. The application programming interface 204 updates 406 the functionality of the news section with new updated content. The user 201 closes the window that displays the news section. The application programming interface 204 clears 407 the news section from the document object model of the web browser.

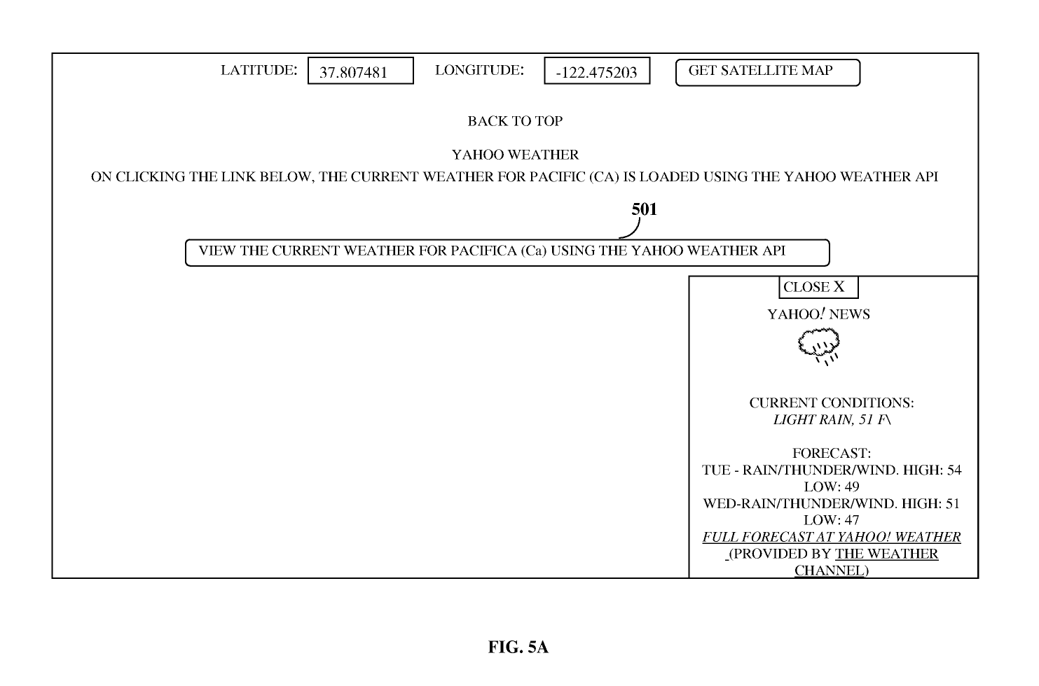

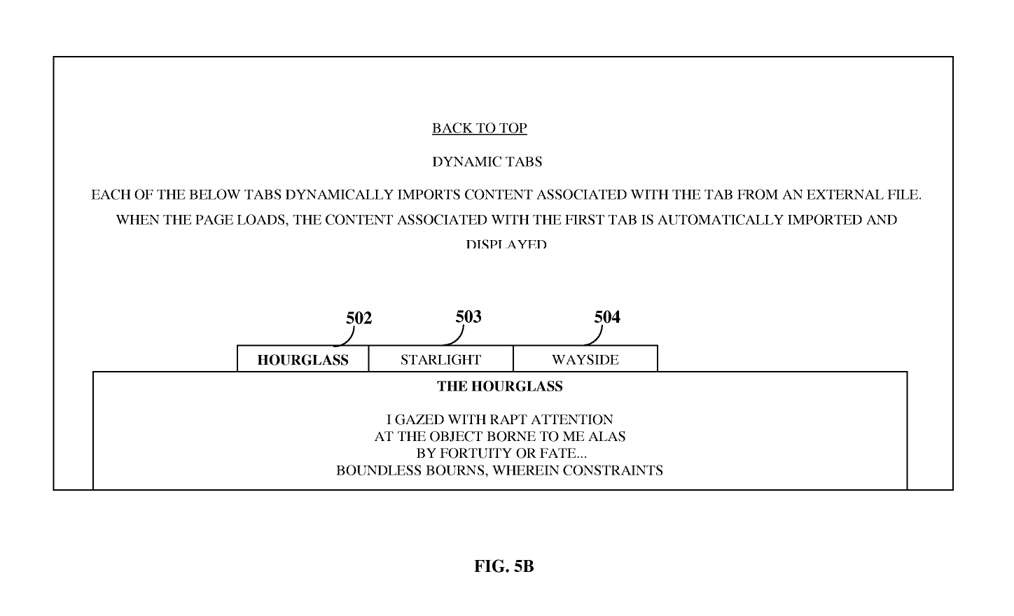

FIGS. 5A-5B, FIGS. 6A-6C, FIGS. 7A-7B, and FIG. 8 exemplarily illustrate screenshots of web pages, where the application programming interface 204 renders dynamic content objects 206 onto the web pages based on an input provided by a user 201. In an embodiment, the source property of the dynamic content object 206 contains either a literal code to be inserted into the web page, or a uniform resource locator (URL) to reference an external source. For example, as exemplarily illustrated in FIG. 5A, the application programming interface 204 defines a method, for example, a “$.get method” in JavaScript to access a weather application programming interface code of Yahoo! Inc. The source property can be customized to include the rendered output of Yahoo's weather application. The user 201 provides an input to view the current weather by clicking on a link 501 on the web page. Based on the user's 201 input, the application programming interface 204, on accessing the weather application programming interface code of Yahoo! Inc., receives extensible markup language (XML) content from the weather application programming interface code of Yahoo! Inc., parses the received XML content using an XMLHttpRequest object and conditionally adds selective content to the web page required to render the output of Yahoo's weather application.

In an embodiment, dynamic content objects 206 can remain open while others are opened on the same web page. The dynamic content objects 206 declared within the same array can be closed automatically when other dynamic content objects 206 are opened. In an embodiment, when a prior dynamic content object 206 is already open, the element triggering the application programming interface 204 is allowed to reopen the same dynamic content object 206 to instantiate a dynamic content object 206 with new settings. In an embodiment, when the dynamic content object 206 is closed, the keyboard focus is automatically returned to the element triggering the application programming interface 204. For example, the application programming interface 204 defines a property declaration “returnFocus: true” for declaring that the focus will return to the triggering element when the associated dynamic content object 206 is closed.

In an embodiment, the application programming interface 204 defines an “is Static” property for allowing a dynamic content object 206 to be inserted into the web page in a specific location instead of being inserted after the triggering element. The “is Static” property contains an object or CSS selector for the desired container tag where the dynamic content is inserted. In an embodiment, as exemplarily illustrated in FIG. 5B, dynamic tabs 502, 503, and 504 are shown as dynamic content objects 206. Each of the tabs 502, 503, and 504 imports external content from a file, for example, a “tabs.html” file created in HTML. The application programming interface 204 assigns a tab functionality to a specific dynamic content object grouping by setting an “isTab” property to true within each related dynamic content object declaration. The user 201 provides an input by selecting one or more of the tabs 502, 503, and 504 provided on the screen. Based on the user's 201 input, the relevant selected tab 502, 503, or 504, which is enabled by setting “isTab” to true, opens on the screen. The setting specifies that screen reader accessible hidden text will automatically be appended to the link text for each associated triggering link. The screen reader accessible hidden text is invisible to sighted users 201, and has no effect on the page layout. For example, when a tab link 502, 503, or 504 is selected, the hidden text “tab selected” is appended to the link text. Similarly, the unselected tabs 502, 503, or 504 in the group will have “tab” appended to the link text instead. The hidden text is automatically changed to accurately reflect the current state of each tab 502, 503, and 504 at runtime.

When “isTab” is set to true, the following property is used by default within the screen reader accessible hidden text. tabRole: “tab” which causes “tab” or “tab selected” to be announced based on the active state. For example, a nested tab could be declared as tabRole: “sub tab” or a panel could be declared as tabRole: “panel”. Any textual value can be used to describe the role of the tab 502, 503, or 504 as long as the value reflects the role of the dynamic content object 206. Similarly, “tabState: selected” can be overridden during setup or at runtime to allow screen reader localization support in multiple linguistic dialects to reflect the active state of the selected tab 502, 503, or 504. In an embodiment, the dynamic content object 206 is set to open when the web page loads. The mode property controls how the dynamic content is fetched. The default mode value is 0. When the mode value is 0, the dynamic content within the source property is inserted into the document object model as a dynamic content object 206. When the mode value is set to 1, external content is automatically fetched and inserted into the document object model as a dynamic content object 206 using the path string declared in the source property.

When the mode value is set to 2, the application programming interface 204 uses the get method to fetch remote content for full customization using a path string declared in the source property. The type of data to be returned to the callback function is, for example, XML data, HTML data, JavaScript object notation (JSON) data, JavaScript object notation with padding (JSONP) data, text, etc. When the mode value is set to 3, the application programming interface 204 uses a “getJSON” method to fetch remote content for full customization using the path string declared in the source property. When the mode value is set to 4, the application programming interface 204 uses a “getScript” method to fetch remote content for full customization using the path string declared in the source property. When the mode value is set to 5, the application programming interface 204 uses a “post” method to fetch remote content for full customization using the path string declared in the source property. When the mode value is set to 6, the application programming interface 204 uses an asynchronous JavaScript and xml (AJAX) method to fetch remote content for full customization using options declared in the ajaxOptions collection object. There are four AJAX methods, for example, “beforeSend”, “success”, “complete”, and “error” that should not be declared in ajaxOptions. These methods already point to overridable methods within each dynamic content object 206 to allow full customization.

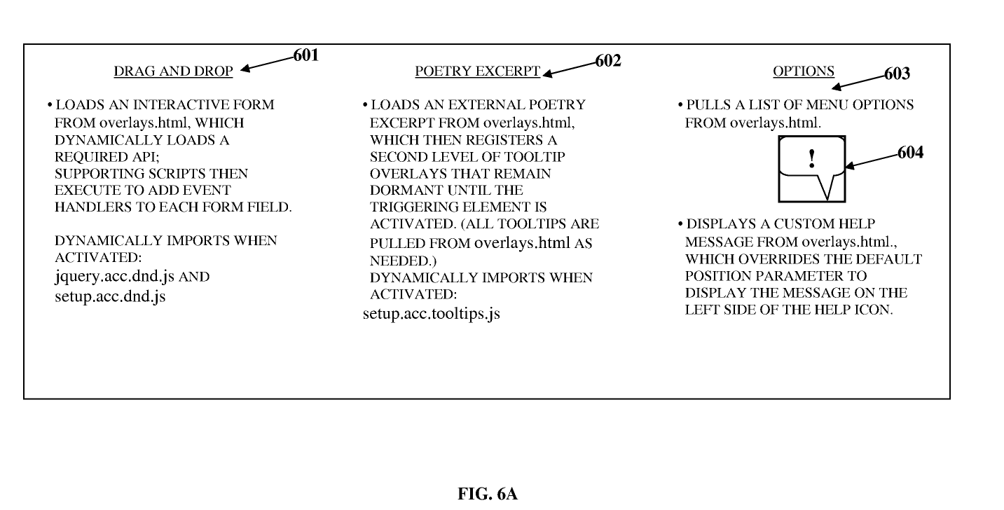

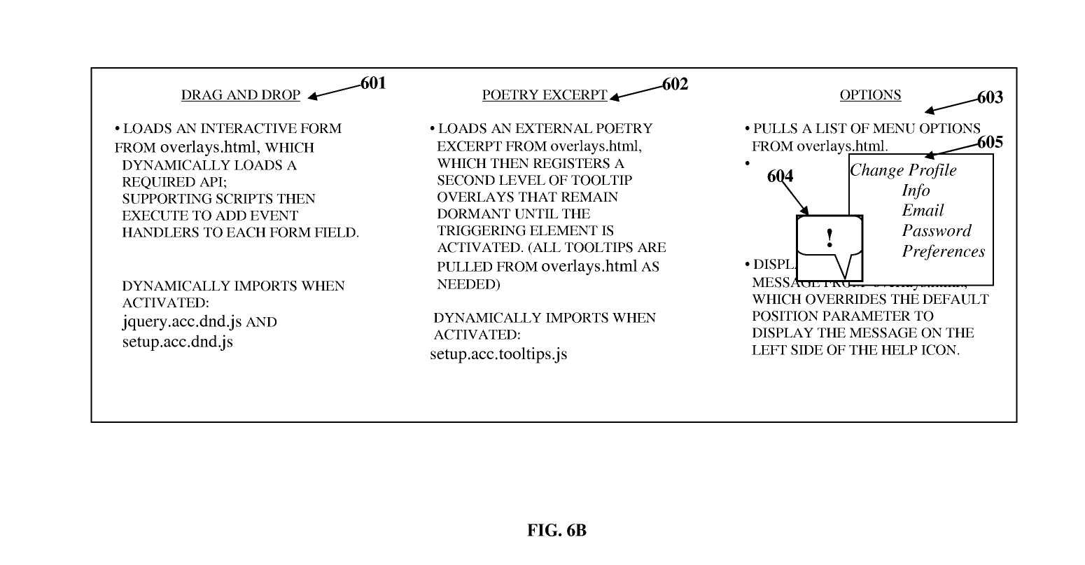

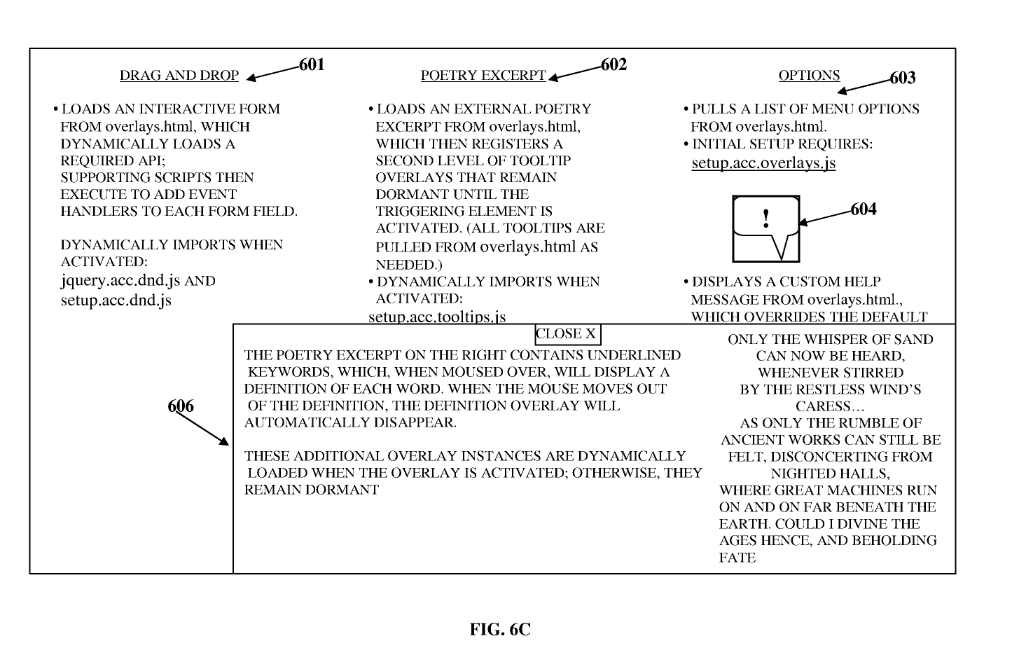

In an embodiment, an optional array of one or more supporting JavaScript (JS) files will be run once when the initial dynamic content object 206 is created. These JavaScript files run before any dynamic content markup is rendered. For example, the drag and drop 601 implementation, as exemplarily illustrated in FIGS. 6A-6C, loads an interactive form which dynamically loads the application programming interface 204. Supporting scripts then execute to add event handlers to each form field after the dynamic content object 206 is rendered. In an embodiment, an optional array of one or more supporting JS files execute before the dynamic content object 206 is opened. In another embodiment, an optional array of one or more supporting JS files execute after the dynamic content object 206 is closed. In another embodiment, optional JS scripts execute after the dynamic content object 206 has finished loading.

In an embodiment, built-in functions are available to handle events, for example, resizing, scrolling, mouse clicks, mouse movements, key strokes, and errors. Built-in functions are also available to handle special events, for example, executing a script before a dynamic content object 206 is closed, executing a script after the dynamic content object 206 is closed, executing a script when focus moves out of the dynamic content object 206, executing a script when the dynamic content object 206 timeout in milliseconds occurs, etc. Built-in functions are also available to handle events pertaining to core functionality, for example, forcing the dynamic content object 206 to open, forcing the dynamic content object 206 to close, returning true or false if the specified dynamic content object 206 is still in the process of loading, returning true if the specified dynamic content object 206 has finished loading and false otherwise, forcing leading screen readers to recognize dynamic content changes immediately, etc.

In an embodiment, a class name for the outerHTML tag of the dynamic content object 206 can be declared uniquely for a declaration if the dynamic content is referencing an external CSS file. When fetching local or remote content that contains a close link, the class name for the link must match the class name declaration in the “closeClassName” property of the same dynamic content object 206. This will ensure that the necessary event handlers are added correctly to each close link when rendered. The application programming interface 204 automatically positions dynamic content objects 206 in a specific location on the screen using positional properties, for example, autoPosition, autoFix, etc. The autoPosition and autoFix properties are used to automatically position dynamic content objects 206 in specific locations on a view port of the screen at runtime.

Dynamic content objects 206 can be used for various purposes. For example, dynamic content objects 206 can be used for providing an interactive lightbox, an information prompt, a drop down menu, a help message, a calendar picker, a login prompt, a timeout notice, etc. These common dynamic content objects 206 demonstrate different implementation types with unique properties during the setup process. For example, as illustrated in FIGS. 6A-6C, the application programming interface 204 loads an external poetry excerpt 602 from a file, for example, overlays.html, which then registers a second level of tooltip dynamic content objects 206 that remain dormant until the triggering element is activated. The application programming interface 204 dynamically imports the files “jquery.acc.dnd.js”, “setup.acc.dnd.js”, and “setup.acc.tooltips.js”, as exemplarily illustrated in FIGS. 6A-6C, when the rendered dynamic content objects 206 are activated on the web pages. The tooltips are pulled from the “overlays.html” file based on the user's 201 input. For example, the application programming interface 204 pulls a list of menu options 603 from the “overlays.html” file to edit information, electronic mail addresses, passwords, and preferences 605 associated with the user's 201 profile as exemplarily illustrated in FIG. 6B. In another example, a help overlay displays a custom help message from the “overlays.html” file, which overrides the default position parameter to display the message on the left side of a help icon 604. In another example as illustrated in FIG. 6C, a link to a poetry excerpt 602 loads an external poetry excerpt 606 from the “overlays.html” file which registers a second level tool tip. The application programming interface 204 dynamically loads these additional overlay instances when the overlay is activated; otherwise the overlay instances remain dormant.

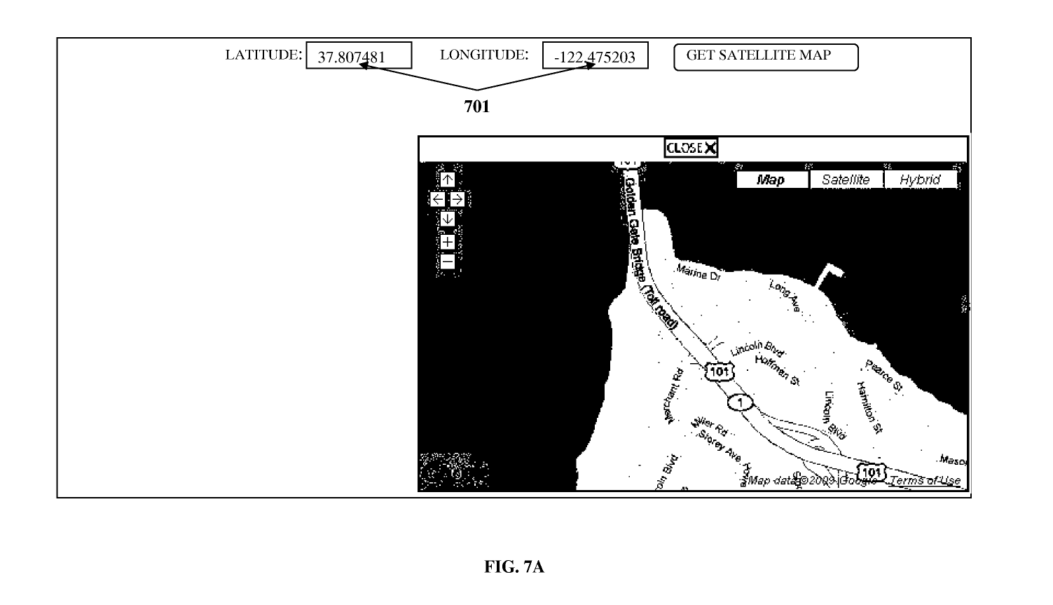

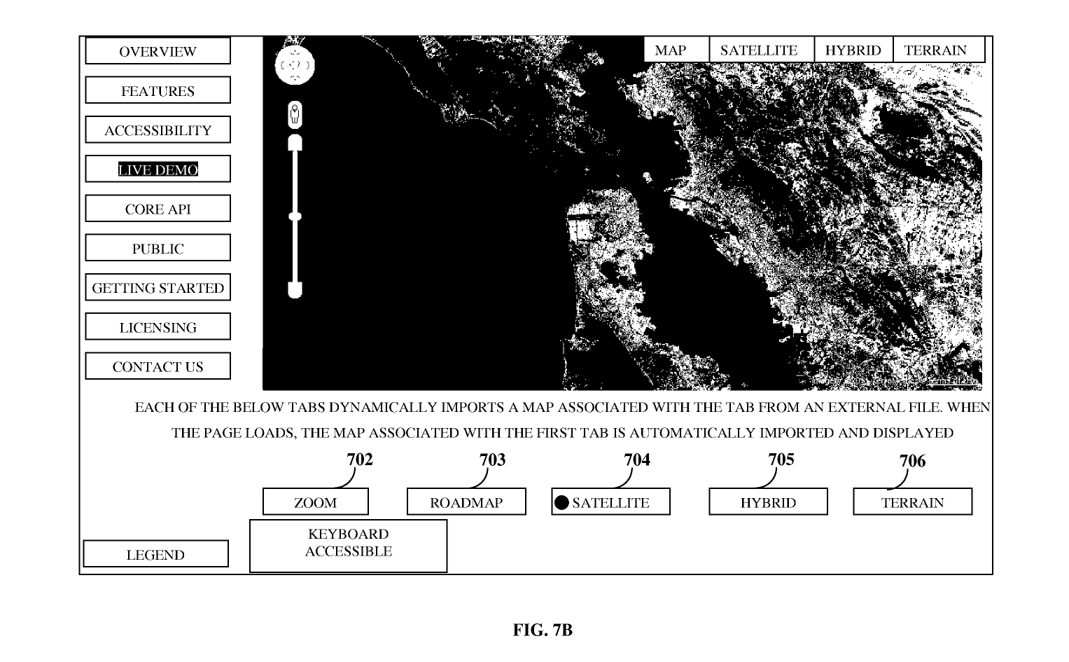

In an embodiment, the standard functionality of the application programming interface 204 can be overridden. For example, the application programming interface 204 receives an application programming interface (API) callback from Google™ Maps based on the given latitude and longitude values 701 as exemplarily illustrated in FIG. 7A. The latitude and longitude values 701 can be changed at runtime to designate new coordinates to fetch every time the dynamic content object 206 is opened. When a user 201 selects a tab from a list of tabs 702, 703, 704, 705, and 706 as exemplarily illustrated in FIG. 7B, the application programming interface 204 receives the associated content from the callback received from the Google™ Maps application based on the selected tab 702, 703, 704, 705, or 706. Each of the dynamic tabs 702, 703, 704, 705, and 706 dynamically imports a map associated with each tab 702, 703, 704, 705, and 706 from an external file. When the web page loads, the application programming interface 204 automatically imports and displays the map associated with one of the tabs 702, 703, 704, 705, and 706 on the web page.

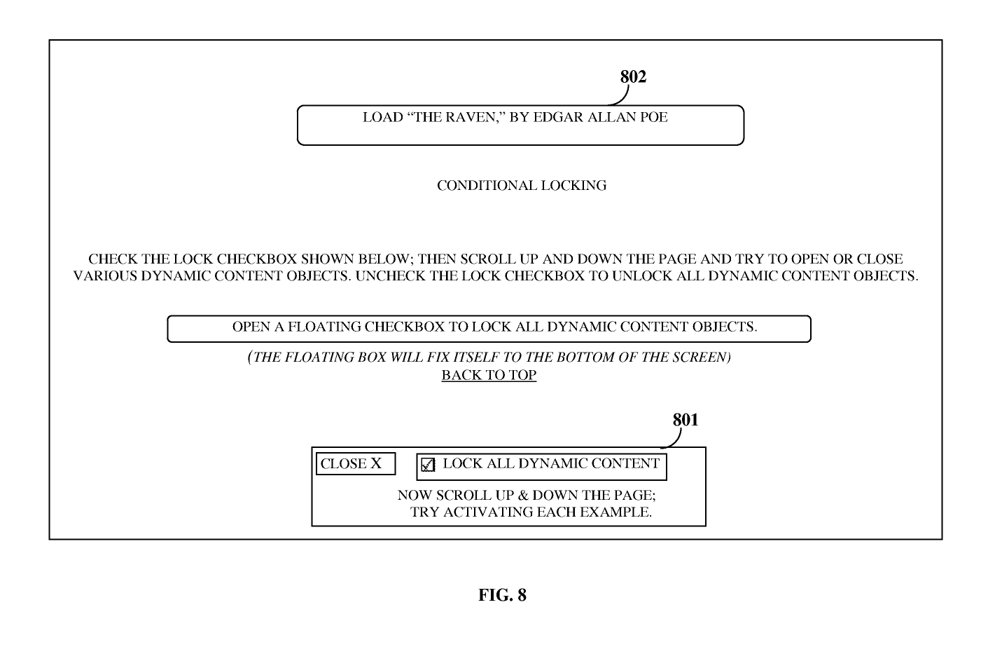

In an embodiment, the application programming interface 204 disclosed herein enables conditional locking which is a method of freezing dynamic content objects 206 in their current open or closed state, allowing for conditional processing to unlock these dynamic content objects 206 later. Conditional locking is useful for displaying a form that requires the user's 201 input before the form can be dismissed, or as long as child dynamic content objects 206 remain open within a locked parent dynamic content object 206. A user 201 provides an input for opening a floating checkbox 801 on the web page to lock dynamic content objects 206 of the web page as exemplarily illustrated in FIG. 8. When an overlay is activated and the floating checkbox 801 has been checked, the floating checkbox 801 locks all the dynamic content objects 206. The floating checkbox 801 fixes itself to the bottom of the screen. The floating checkbox 801 needs to be unchecked to unlock the dynamic content objects 206 on the screen. Also exemplarily illustrated in FIG. 8, is a button link 802 provided on the web page for loading a dynamic content object 206, for example, a poem.

Since the application programming interface 204 disclosed herein supports jQuery AJAX API methods, for example, load, get, getScript, getJSON, post, and AJAX, all remotely hosted APIs and server side callbacks receive the same level of quality, performance, and accessibility as locally referenced data sources. The application programming interface 204 acts as a portal to utilize publicly available remote-fetching methods within the jQuery API, allowing applications to insert dynamic content objects 206 into the web page only when a user 201 performs a specific action within a web page or web application. The application programming interface 204 can pull content from another dynamic content object 206 within the same document object model to be rendered in a specific location on the web page based on developer preferences, allowing the developer the flexibility to capture content from any location, locally or remotely, to be rendered as desired on the web page at runtime.

The configuration of the application programming interface 204 disclosed herein is handled by the developer during creation of the functionality for a web page or application. Furthermore, since the nested dynamic content objects 206 are instantiated only when needed, and the closed dynamic content objects 206 are automatically removed from the document object model to prevent cluttering and memory leaks, the web page performance and reliability is guaranteed no matter how long the web page is used by repeatedly opening and closing the dynamic content objects 206.

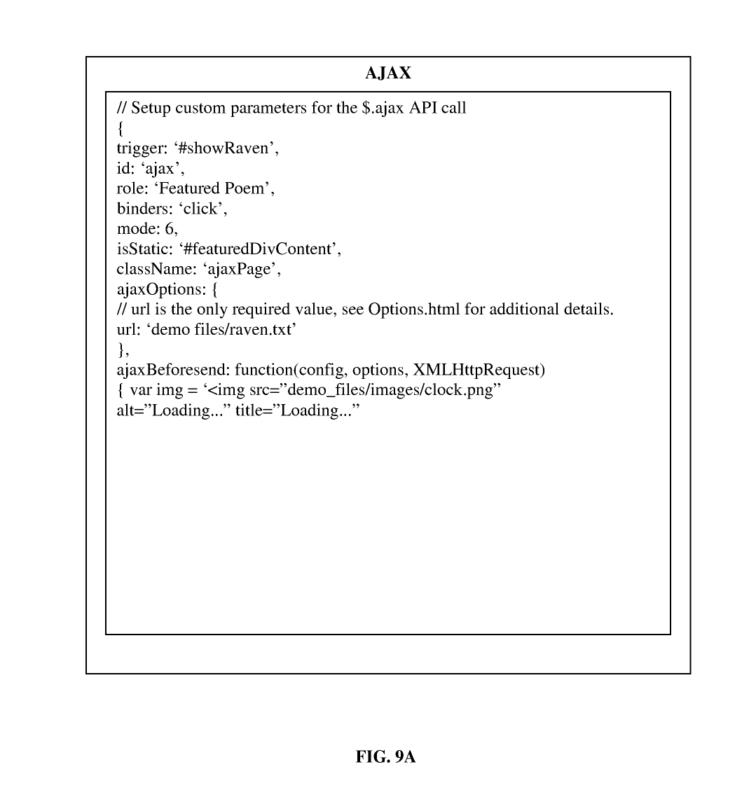

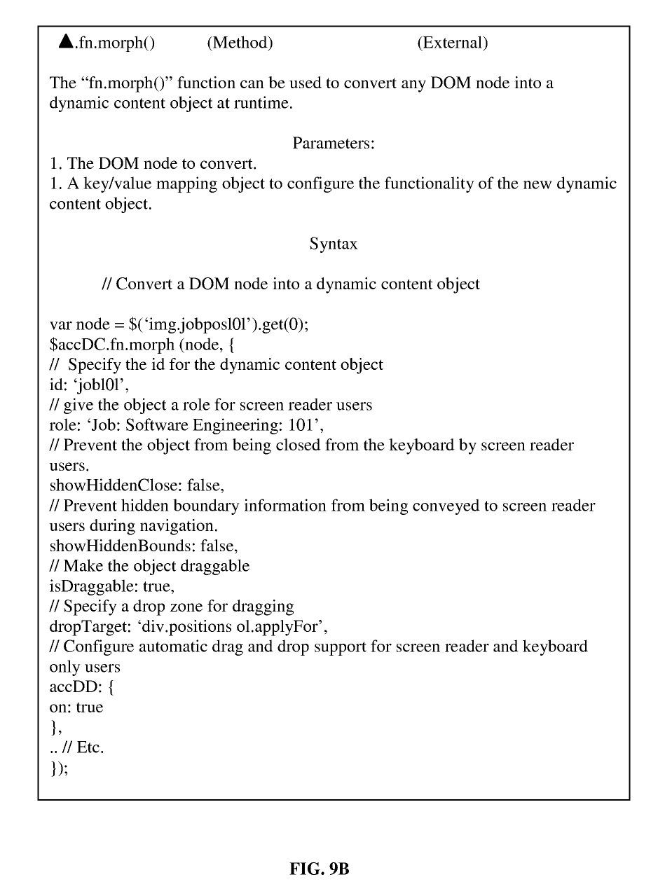

FIGS. 9A-9B exemplarily illustrate a code component that defines a document object in a document object model using a retrieved dynamic content object 206. The code component as exemplarily illustrated in the FIG. 9A triggers a dynamic content object 206 from a document, for example, raven.txt, containing textual information using the AJAX retrieval mode. The code component uses an initial setup file to setup custom parameters for a function call to the application programming interface 204 using an AJAX method. The custom parameters comprise, for example, a URL, a triggering element associated with the name of the dynamic content object 206, for example, #showRaven, an identification parameter for the code component, a role parameter, a binder parameter, a mode property, an “is Static” property, a class name parameter, and one or more options declared in a function called ajaxOptions. The URL is a parameter to be declared in the function ajaxOptions for retrieving the dynamic content object 206 and importing the dynamic content. The code component comprises a function with parameters, for example, parameters to configure the application programming interface 204, one or more options, and a request object to request for a document.

The code component of the application programming interface 204, as exemplarily illustrated in FIG. 9B, comprises a function, for example, fn.morph( ) defined in JavaScript, used to define a document object or DOM node in the document object model with a dynamic content object 206 at runtime. A key/value mapping object configures the functionality of the dynamic content objects 206. Defining the DOM node with a dynamic content object 206 comprises specifying identification for the dynamic content object 206 as a parameter in the function fn.morph( ) The dynamic content object 206 is associated with a role. The dynamic content object 206 is prevented from being closed from the keyboard by screen reader users 201. Boundary information associated with the location of the dynamic content object 206 is hidden from the screen reader users 201. The dynamic content object 206 is made draggable by setting a property, for example, isDraggable, to true. A drop zone on the screen is specified for dragging the dynamic content object 206. The code component configures support for screen reader users 201 to automatically drag and drop the dynamic content object 206.

In an embodiment, the application programming interface 204 can be globally extended, for example, by adding plug-ins to a namespace associated with the application programming interface 204 during setup or at runtime, which can be used to enhance the functionality of the dynamic content objects 206. The dynamic content objects 206 can be locally extended by adding extensions to the existing namespace of the application programming interface 204, for example, “dc” namespace during setup or at runtime, which can be used to enhance the functionality of individual dynamic content objects 206.

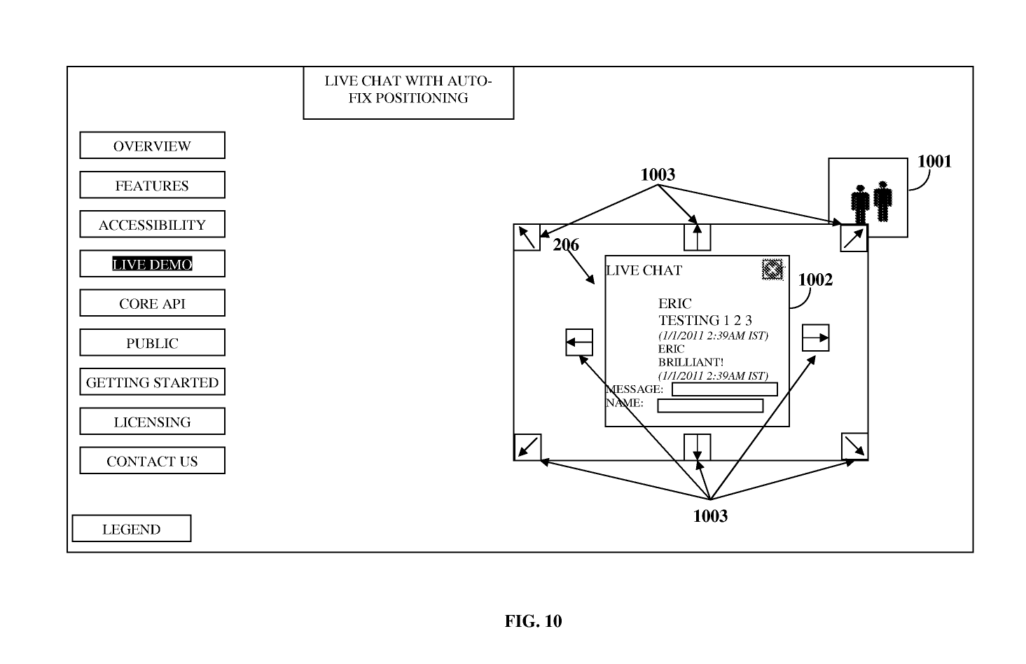

FIG. 10 exemplarily illustrates a chat icon 1001 on a web page for triggering a chat component 1002 as a dynamic content object 206 on the web page. The chat component 1002 allows entry of a message and name of the user 201 using a message field and a name field respectively. The chat component 1002 is rendered onto the display screen of the user's 201 computing device 202. The chat component 1002 is also periodically updated with new incoming messages. The chat icon 1001 is the triggering element for a chat dynamic content object 206, which is fixed to a central position in the viewport when a chat window is first opened. The chat dynamic content object 206, when open, includes surrounding compass point icons 1003 that dynamically fix the chat dynamic content object 206 to a relative location in the viewport when activated. When a message and name value is entered within the chat dynamic content object 206 and a return key is pressed, the chat message is posted to a server side script, and the new message is simultaneously populated within every page that contains an open chat dynamic content object 206. Whenever a new message is rendered within the chat dynamic content object 206, the new message is automatically announced to screen reader users 201 using auto stacking, so that multiple messages can be announced sequentially without causing speech interruptions when queuing sequential announcements.

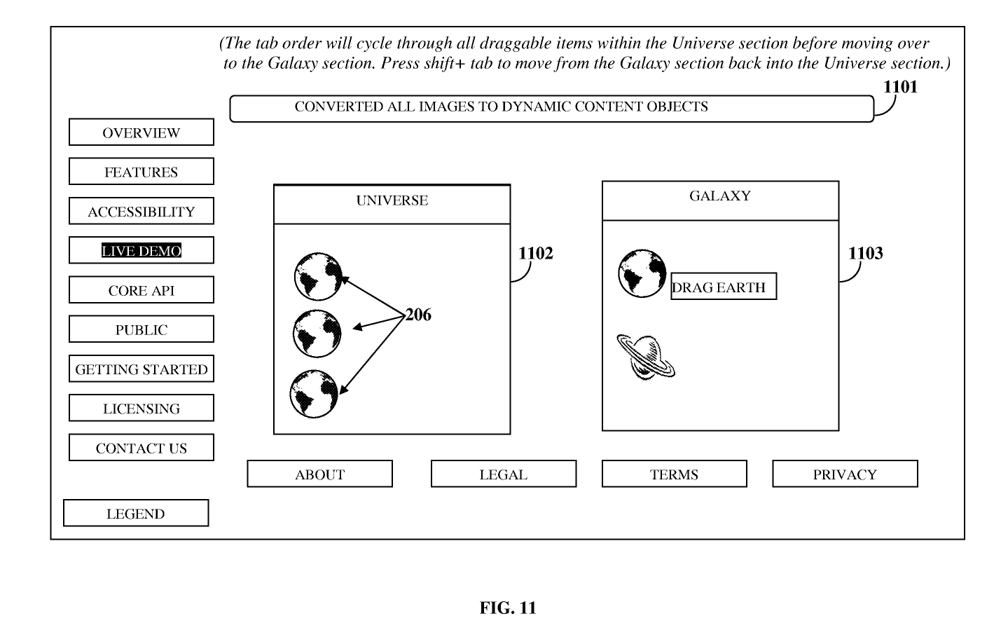

FIG. 11 exemplarily illustrates images rendered as dynamic content objects 206 on a web page by the application programming interface 204. The images are standard image tags contained within an unordered list markup. When a user 201 clicks a button 1101, the keyboard focus is set and the images are dynamically converted into draggable dynamic content objects 206. After conversion, an area titled “Universe” 1102 and an area titled “Galaxy” 1103 are configured as drop targets allowing images to be dragged from “Universe” 1102 to “Galaxy” 1103 by using the mouse. Furthermore, each dynamic content object 206 is configured to be draggable using the keyboard. For example, the user 201 clicks the button 1101 to check keyboard focus. The user 201 can tab between the draggable dynamic content objects 206. The user 201 presses “enter” on the dynamic content objects 206 that the user 201 wishes to toggle draggability. The user 201 presses “tab” on the keyboard to drop the target image, and presses “enter” on the keyboard to drop the previously selected objects 206 in the new locations. The draggable dynamic content objects 206 that include specified drop targets are automatically accessible to screen reader and keyboard only users 201 via keyboard accessible drag and drop links that are conditionally displayed when they receive focus.

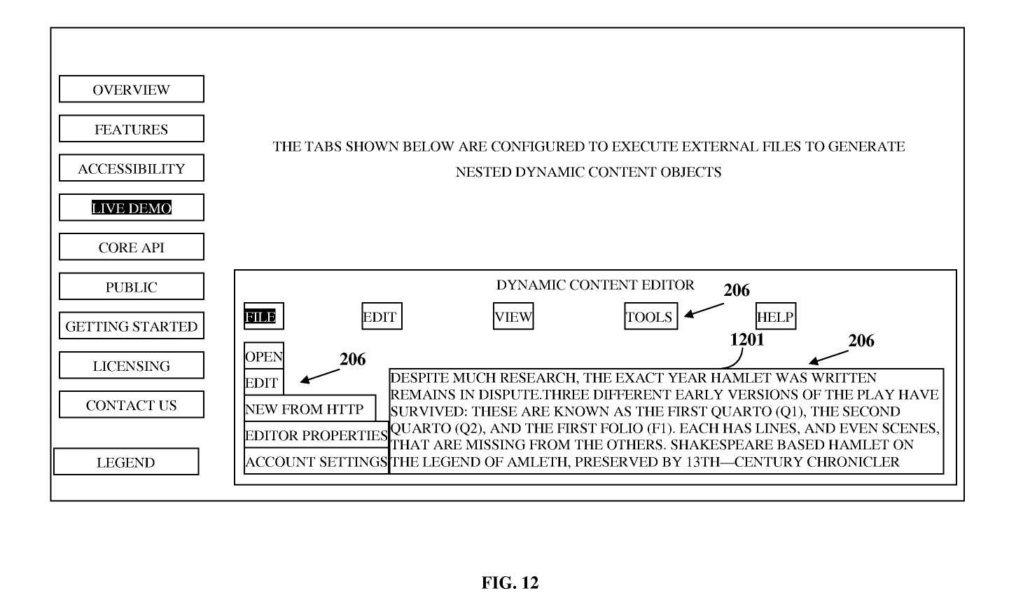

FIG. 12 exemplarily illustrates extensible markup language (XML) generated drop down menus rendered as nested dynamic content objects 206 on a web page by the application programming interface 204. The content shown in the text block 1201 is edited by activating an edit content link, which opens an editor as a dynamic content object 206. The application programming interface 204 programmatically generates a menu bar from an external XML file, for example, menubar.xml, and renders the menu bar as a nested dynamic content object 206. The menu bar comprises the options “file”, “edit”, “view”, “tools”, and “help”. The tabs titled “file”, “edit”, “view”, “tools”, “help”, etc., are configured to execute external files to generate nested dynamic content objects 206 as the content of drop down menus. Whenever the user 201 activates the menu bar link, the application programming interface 204 renders a nested dynamic content object 206 as a drop down menu containing a list of option links, which when clicked, generate another nested dynamic content object 206 to temporarily appear as a dynamically positioned tooltips. The text of the tooltips is automatically announced to the screen reader users 201. The editor dynamic content object 206 displays a text area with the content from the text block 1201. The application programming interface 204 renders the options in the menu bar and the nested dynamic content objects 206 as a drop down menu containing a list of option links that are used to edit the content in the text area. When the editor dynamic content object 206 is closed, the content of the text area 1201 is automatically added to the text block 1201.

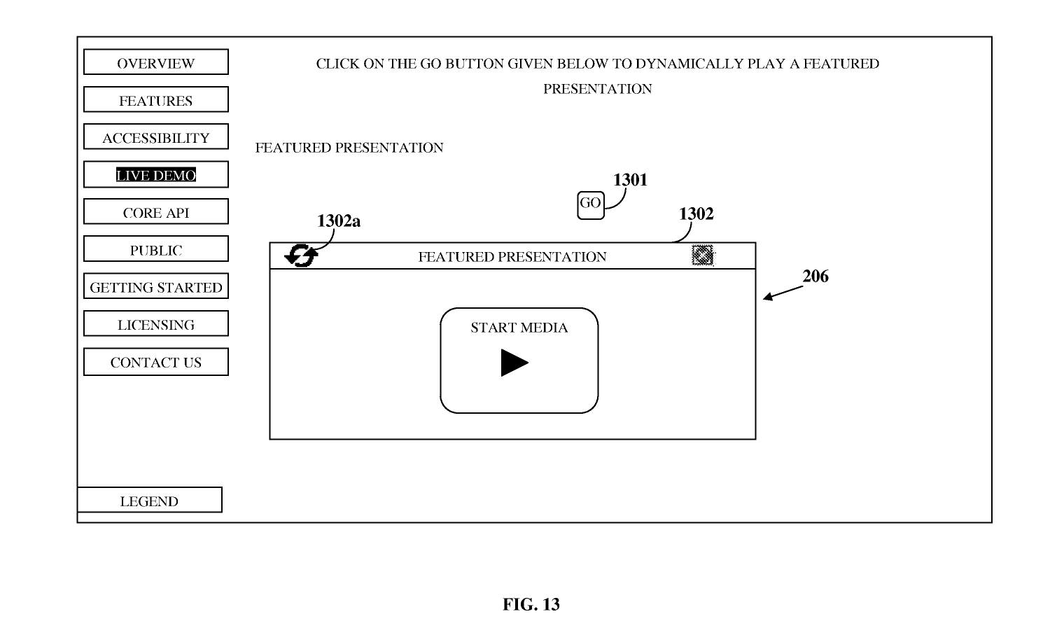

FIG. 13 exemplarily illustrates an audio visual player 1302 rendered as a nested dynamic content object 206 on a web page by the application programming interface 204. The application programming interface 204 renders a dialog box on the browser application 205 as a nested dynamic content object 206. A form comprising options to select a featured presentation programmatically configures a player 1302 that is rendered as a dynamic content object 206 when the user 201 activates a “go” button 1301. The go button 1301 is repeatedly activated to reflect new selections. The player dynamic content object 206 comprises a dynamically generated Flash player 1302, which is an alternative option for browsers that do not support Flash. A drag icon 1302a at the top left hand corner of the player dynamic content object 206 is used to drag the player dynamic content object 206 to a location of the screen. The location of the player dynamic content object 206 will remain persistent after the player dynamic content object 206 is repeatedly closed and reopened by clicking the go button 1301.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes the main memory. Volatile media comprise, for example, a register memory, processor cache, a random access memory (RAM), etc. Transmission media comprise, for example, coaxial cables, copper wire and fiber optics, including the wires that constitute a system bus coupled to a processor. Common forms of computer readable media comprise, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device, and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as an object code. The computer program product disclosed herein comprises computer executable instructions embodied in a non-transitory computer readable storage medium, wherein the computer program product comprises computer program codes for implementing the processes of various embodiments.

The present invention can be configured to work in a network environment including a computer that is in communication, via a communications network, with one or more devices. The computer may communicate with the devices directly or indirectly, via a wired or wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for creating and managing dynamic content on a web page, comprising:
providing an application programming interface that interacts with a browser application of a user, wherein said browser application comprises a plurality of document objects contained in a document object model;
triggering retrieval of one or more of a plurality of dynamic content objects on said web page based on an input provided by said user;
dynamically retrieving said one or more dynamic content objects from one or more of local memory locations and remotely hosted memory locations by said application programming interface;
updating said document object model of said browser application using said retrieved one or more dynamic content objects by said application programming interface, wherein said retrieved one or more dynamic content objects define said document objects in said document object model;
dynamically rendering said retrieved one or more dynamic content objects onto said web page from said document objects contained in said updated document object model by said application programming interface; and
updating functionality of said rendered one or more dynamic content objects on said web page at runtime by said application programming interface;
whereby said application programming interface in communication with said browser application creates and manages said dynamic content on said web page.

2. The computer implemented method of claim 1, further comprising dynamically generating one or more nested dynamic content objects in said retrieved one or more dynamic content objects by said application programming interface, wherein said dynamically generated one or more nested dynamic content objects are dormant prior to activation of said retrieved one or more dynamic content objects.

3. The computer implemented method of claim 1, further comprising providing accessibility for each of said one or more dynamic content objects by said application programming interface.

4. The computer implemented method of claim 1, further comprising enabling said rendered one or more dynamic content objects to conform to a plurality of content guidelines by said application programming interface.

5. The computer implemented method of claim 1, further comprising automatically clearing dormant dynamic content objects from said document object model by said application programming interface for preventing cluttering and memory leaks in said document object model.

6. The computer implemented method of claim 1, wherein said rendered one or more dynamic content objects are interpretable by output devices that render said retrieved one or more dynamic content objects to said user.

7. The computer implemented method of claim 1, further comprising passing said retrieved one or more dynamic content objects from said web page to another web page by said application programming interface for sharing data and resources.

8. The computer implemented method of claim 1, wherein said application programming interface supports a plurality of browser applications accessible over a plurality of computing devices.

9. A computer implemented system for creating and managing dynamic content on a web page, comprising:
an application programming interface that interacts with a browser application of a user, wherein said browser application comprises a plurality of document objects contained in a document object model, wherein said application programming interface comprises:
an object retrieval module that triggers retrieval of one or more of a plurality of dynamic content objects on said web page based on an input provided by said user;
said object retrieval module that dynamically retrieves said one or more dynamic content objects from one or more of local memory locations and remotely hosted memory locations;
an object updating module that updates said document object model of said browser application using said retrieved one or more dynamic content objects, wherein said retrieved one or more dynamic content objects define said document objects in said document object model;
an object rendering module that dynamically renders said retrieved one or more dynamic content objects onto said web page from said document objects contained in said updated document object model; and
a function updating module that updates functionality of said rendered one or more dynamic content objects on said web page at runtime.

10. The computer implemented system of claim 9, wherein said object updating module dynamically generates one or more nested dynamic content objects in said retrieved one or more dynamic content objects, wherein said dynamically generated one or more nested dynamic content objects are dormant prior to activation of said retrieved one or more dynamic content objects.

11. The computer implemented system of claim 9, wherein said application programming interface further comprises a memory management module that automatically clears dormant dynamic content objects from said document object model for preventing cluttering and memory leaks in said document object model.

12. The computer implemented system of claim 9, wherein said application programming interface further comprises a guideline conformance module that enables said rendered one or more dynamic content objects to conform to a plurality of content guidelines.

13. The computer implemented system of claim 9, wherein said application programming interface further comprises a content object accessibility module that provides accessibility for each of said one or more dynamic content objects.

14. The computer implemented system of claim 9, wherein said object rendering module passes said retrieved one or more dynamic content objects from said web page to another web page for sharing data and resources.

15. A computer program product comprising computer executable instructions embodied in a non-transitory computer readable storage medium, wherein said computer program product comprises:
a first computer program code for providing an application programming interface that interacts with a browser application of a user, wherein said browser application comprises a plurality of document objects contained in a document object model;
a second computer program code for triggering retrieval of one or more of a plurality of dynamic content objects based on an input provided by said user;
a third computer program code for dynamically retrieving said one or more dynamic content objects from one or more of local memory locations and remotely hosted memory locations by said application programming interface;
a fourth computer program code for updating said document object model of said browser application using said retrieved one or more dynamic content objects by said application programming interface, wherein said retrieved one or more dynamic content objects define said document objects in said document object model;
a fifth computer program code for dynamically rendering said retrieved one or more dynamic content objects onto said web page from said document objects contained in said updated document object model by said application programming interface; and
a sixth computer program code for updating functionality of said rendered one or more dynamic content objects on said web page at runtime by said application programming interface.

16. The computer program product of claim 15, further comprising a seventh computer program code for dynamically generating one or more nested dynamic content objects in said retrieved one or more dynamic content objects by said application programming interface, wherein said dynamically generated one or more nested dynamic content objects are dormant prior to activation of said retrieved one or more dynamic content objects.

17. The computer program product of claim 15, further comprising an eighth computer program code for automatically clearing dormant dynamic content objects from said document object model by said application programming interface for preventing cluttering and memory leaks in said document object model.

18. The computer program product of claim 15, further comprising a ninth computer program code for enabling said rendered one or more dynamic content objects to conform to a plurality of content guidelines by said application programming interface.

19. The computer program product of claim 15, further comprising a tenth computer program code for passing said retrieved one or more dynamic content objects from said web page to another web page by said application programming interface for sharing data and resources.
